(19) United States
(12) Patent Application Publication
(10) Pub. No.: US 2023/0155438 A1
(43) Pub. Date: May 18, 2023

(54) STATOR, MOTOR INCLUDING THE SAME AND STATOR ASSEMBLING METHOD

(71) Applicant: INDUSTRIAL TECHNOLOGY RESEARCH INSTITUTE, Hsinchu (TW)

(72) Inventors: Sheng-Tsz LIU, Hsinchu City (TW); Chun-Yen OU, New Taipei City (TW); Yu-Ting SU, Tainan City (TW); Lin-Yen PENG, Hsinchu County (TW); Yang-Guang LIU, Hsinchu County (TW); Yu-Choung CHANG, Hsinchu County (TW)

(73) Assignee: INDUSTRIAL TECHNOLOGY RESEARCH INSTITUTE, Hsinchu (TW)

(21) Appl. No.: 17/702,556

(22) Filed: Mar. 23, 2022

(30) Foreign Application Priority Data
Nov. 18, 2021 (TW) 110142897

(51) Int. Cl. H02K 3/38; H02K 3/34; H02K 3/28; H02K 1/16

(52) U.S. Cl. CPC H02K 3/38; H02K 3/34; H02K 3/28; H02K 1/16; H02K 2203/03; H02K 2211/03

(57) ABSTRACT

A stator includes a stator core and at least one fastener, the stator core includes a lamination, a shaft disposed through the lamination, and at least one insulator disposed on the lamination and configured to be wound with a wire. The fastener is disposed on the at least one insulator and configured for the wire to be wound thereon and for fixing at least one cable coming out from the shaft so as to electrically couple the wire and the at least one cable.

### CROSS-REFERENCE TO RELATED APPLICATIONS

This non-provisional application claims priority under 35 U.S.C. § 119(a) on Patent Application No(s). 110142897 filed in Taiwan on Nov. 18, 2021, the entire contents of which are hereby incorporated by reference.

### TECHNICAL FIELD

The disclosure relates to a stator, more particularly to an internal stator, a motor including the same, and a stator assembling method for the same.

### BACKGROUND

A brushless DC (BLDC) motor is an electric motor powered by a direct current voltage supply and commutated electronically instead of by brushes like in conventional DC motors. It is known that the BLDC motors feature increased torque per power input, increased reliability, lower maintenance requirement, and reduced operational and mechanical noise compared to their brushed counterparts, thus they are widely used in various fields, such as aerospace, national defense, agricultural industry, manufacturing and residential business and people's livelihood, as a power source in a mechanical-driven operation.

To meet market demand, the relevant industries have focused on how to improve the manufacturing process for BLDC motors in recent years. Taking the external-rotor BLDC motor as an example, the external-rotor BLDC motor is commonly used in ceiling fans, its stator is installed on a down rod which is fixed at the ceiling, and the coil wires of the stator need to be electrically connected to cables arranged along the rod for providing electrical current to the stator. To this end, the shaft and the down rod are hollow for accommodating the cables, and the shaft has an opening near the stator core to allow the cables to go out and couple with the coil wires; however, the conventional processes for that is inefficiency. In specific, before coupling the coil wires and the cables, the terminals of coil wires are needed to be properly categorized, trimmed to a proper length, and bundled into leads for connecting to power supply, the parts of the cables coming out of the shaft are needed to be properly arranged and tied for them to connect to the lead wires; then, the lead wires and the respective cables are welded to each other, and then the protection sleeves and cable ties are applied on the lead wires and the cables to achieve a reliable connection. Most of the aforementioned steps can only be implemented manually. Thus, the conventional manufacturing process is costly and time-consuming and difficult to achieve a balance between quality and production yield.

### SUMMARY

One embodiment of the disclosure provides a stator including a stator core and at least one fastener. The stator core includes a lamination, a shaft disposed through the lamination, and at least one insulator disposed on the lamination and configured to be wound with a wire. The fastener is disposed on the at least one insulator. The at least one fastener is configured for the wire to be wound thereon and for fixing at least one cable coming out from the shaft so as to electrically couple the wire and the at least one cable.

Another embodiment of the disclosure provides a motor including a rotor and a stator. The stator includes a stator core and at least one fastener. The stator core includes a lamination accommodated in the rotor, a shaft disposed through the lamination and the rotor, and at least one insulator disposed on the lamination and configured to be wound with a wire. The fastener is disposed on the at least one insulator. The at least one fastener is configured for the wire to be wound thereon and for fixing at least one cable coming out from the shaft so as to electrically couple the wire and the at least one cable.

Another embodiment of the disclosure provides a stator assembling method including providing a stator core, assembling at least one fastener on at least one insulator of a lamination of the stator core, winding a wire onto the at least one insulator and fixing the wire to the at least one fastener, and fixing at least one cable coming out from a shaft of the stator core to the at least one fastener.

According to the stator, the motor, and the stator assembling method as discussed in the above embodiments of the disclosure, the fastener provided on the insulator of the stator can be used for the fixation of both the wire and the cable, thus the parts of the wires, that are from different phases or brought out of the stator core for connection, and the cables are allowed to be automatically fixed together during an automatic stator winding process.

### BRIEF DESCRIPTION OF THE DRAWINGS

The present disclosure will become better understood from the detailed description given hereinbelow and the accompanying drawings which are given by way of illustration only and thus are not intending to limit the present disclosure and wherein:

FIG. 1 is an exploded view of a fan with a motor according to one embodiment of the disclosure;

FIG. 2 is an exploded view of the motor in FIG. 1;

FIG. 3 is a perspective view of a stator of the motor in FIG. 2;

FIG. 4 is an exploded view of the stator in FIG. 3;

FIG. 5 is an exploded view of a circuit board with a fastener according to one embodiment of the disclosure;

FIG. 6 is a partially enlarged view of the stator of the motor in FIG. 2;

FIG. 7 is a flowchart showing steps of assembling the stator according to one embodiment of the disclosure;

FIG. 8 is a perspective view of a fastener according to another embodiment of the disclosure; and

FIG. 9 is a perspective view of a fastener according to yet another embodiment of the disclosure.

### DETAILED DESCRIPTION

Aspects and usages of the disclosure will become apparent from the following detailed descriptions with the accompanying drawings. The inclusion of such details provides a thorough understanding of the disclosure sufficient to enable one skilled in the art to practice the described embodiments but it is for the purpose of illustration only and should not be understood to limit the disclosure. On the contrary, it is intended to cover alternatives, modifications, and equivalents as can be included within the spirit and scope of the described embodiments as defined by the appended claims. To this end, those skilled in the relevant art will recognize and appreciate that many changes can be made to the various aspects of the disclosure described herein, while still obtaining the beneficial results of the present disclosure. It will also be apparent that some of the desired benefits of the present disclosure can be obtained by selecting some of the features of the present disclosure without utilizing other features.

It is to be understood that the phraseology and terminology used herein are for the purpose of better understanding the descriptions and should not be regarded as limiting. Unless specified or limited otherwise, the terms “mounted,” “connected,” and variations thereof are used broadly and encompass both direct and indirect mountings and connections. As used herein, the terms “substantially” or “approximately” may describe a slight deviation from a target value, in particular a deviation within the production accuracy and/or within the necessary accuracy, so that an effect as present with the target value is maintained. Unless specified or limited otherwise, the phrase “at least one” as used herein may mean that the quantity of the described element or component is one or more than one but does not necessarily mean that the quantity is only one. The term “and/or” may be used herein to indicate that either or both of two stated possibilities.

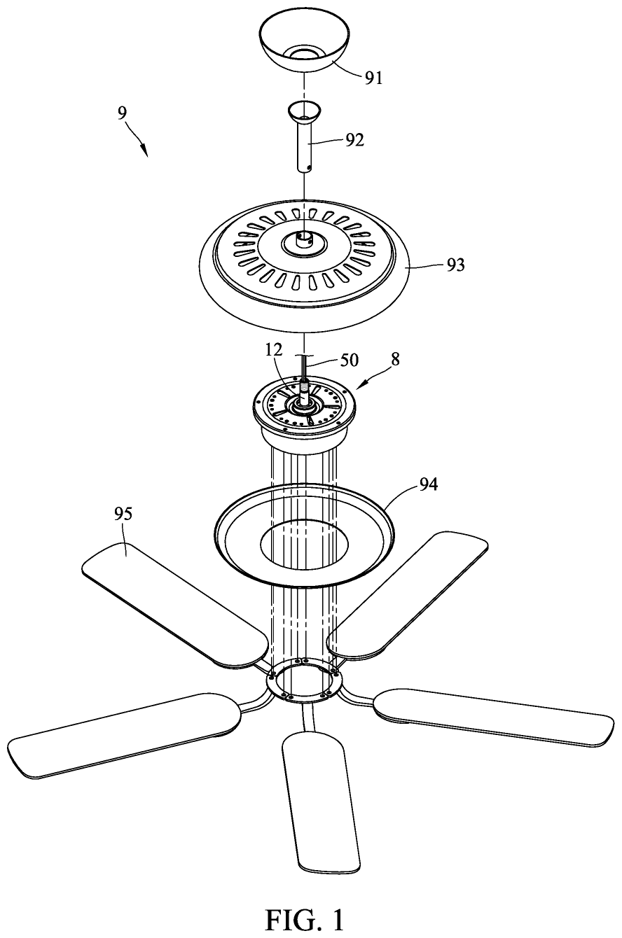

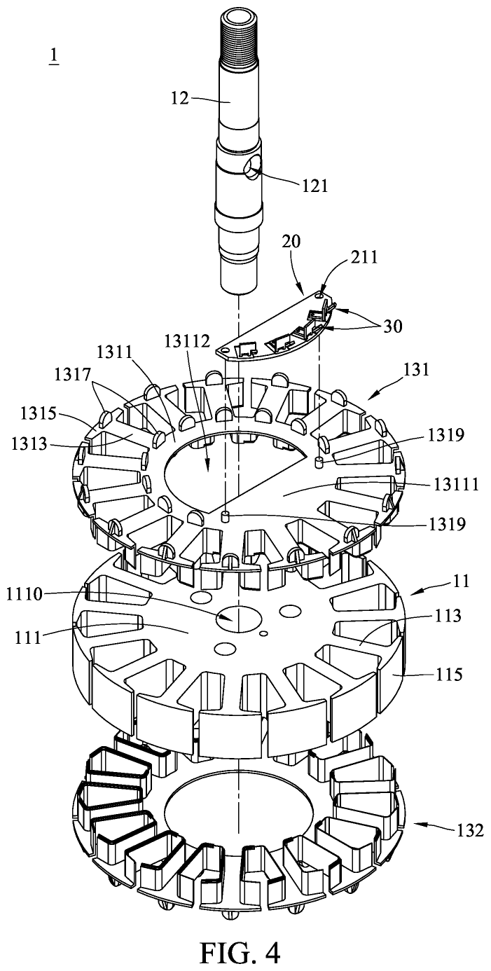

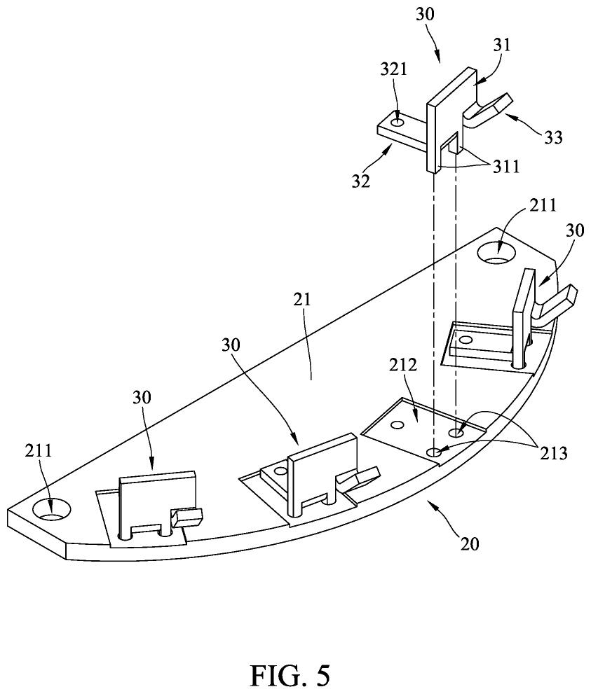

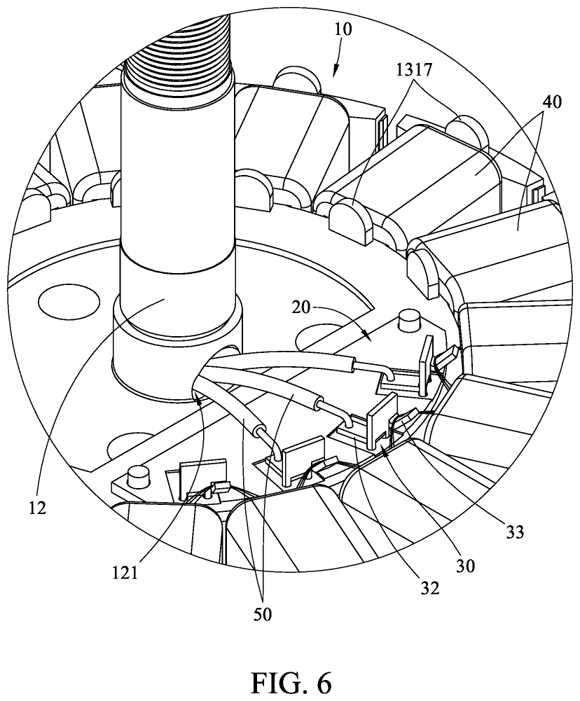

Some exemplary embodiments of the disclosure will be described in detail below with reference to FIGS. 1-9, and the details given in the following paragraphs are merely provided for better comprehension of the spirit of the disclosure.

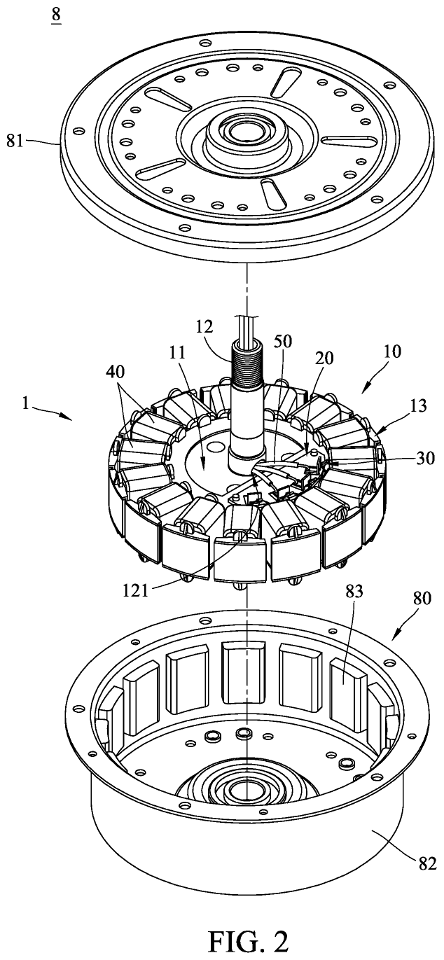

Firstly, please see FIGS. 1-2, one embodiment of the disclosure provides a motor 8 which is applicable to, for example, a fan 9. The motor 8 is, for example, a brushless DC (BLDC) electric motor. As shown, the motor 8 includes a stator 1 and a rotor 80. The stator 1 is accommodated in the rotor 80, thus the stator 1 can be served as an internal stator, and the rotor 80 can be served as an external rotor. The stator 1 has one or more wires 40 wound thereon. The wire 40 can be wound around each of the stator teeth of the stator 1 to form a stator coil (not numbered). The stator coil of the wire 40 is for creating magnetic fields and producing rotation of the rotor 80. The rotor 80 has a first casing 81 and a second casing 82 which form a housing for accommodating the stator 1. In such an arrangement, the motor 8 is known as an external-rotor brushless DC (BLDC) motor. In addition, as shown, the stator 1 includes a shaft 12 thereon and penetrating through one side of the rotor 80 (e.g., the first casing 81).

The fan 9 is, for example, a ceiling fan. As shown, the fan 9 includes a canopy 91, a down rod 92, a first cover 93, a second cover 94, and a plurality of blades 95. The canopy 91 is configured to be fixed to ceiling (not shown). One end of the down rod 92 is fixed to the canopy 91, and the other end of the down rod 92 is fixed to the first cover 93 and connected to the shaft 12 of the motor 8 accommodated within the first cover 93 and the second cover 94. The shaft 12 and the down rod 92 are both hollow so that at least one cable 50 can be disposed therethrough. As such, one or more cables 50 are allowed to be disposed along the down rod 92 and the shaft 12. The shaft 12 has a cable outlet 121 for the cables 50, such that the cables 50 are allowed to go out of the shaft 12 and to be electrically coupled with the wire 40 on the stator 1, thereby providing electricity to the motor 8. Note that any cable that is suitable for being electrically connected to the wire 40 can be employed herein, and the number of the cable 50 is exemplary and not intended to limit the disclosure. The wire 40 is made of, for example, copper; however, the wire 40 and its material and size are exemplary and not intended to limit the disclosure. It is also noted that the wire 40 may be depicted in a simplified manner or omitted in the drawings for the purpose of simple illustration. As electric current flows through the wire 40, a rotating magnetic field is generated to attract magnets 83 on the rotor 80, thus the rotor 80 is forced to rotate around the shaft 12. The blades 95 can be directly or indirectly fixed to a proper area (e.g., the second casing 82) of the rotor 80 and therefore can be rotated with the rotor 80.

The fan 9 is depicted merely for a better understanding of the disclosure illustrated below but is not to limit the applications of the disclosure; that is, the motor as discussed in the disclosure can be applied to other types of fans. For example, the motor of other embodiments of the disclosure can be used in a recirculation fan or a wind machine. In addition, the rotor 80 is depicted merely for a better understanding of the disclosure as well, thus any modification can be made to the rotor 80 as required.

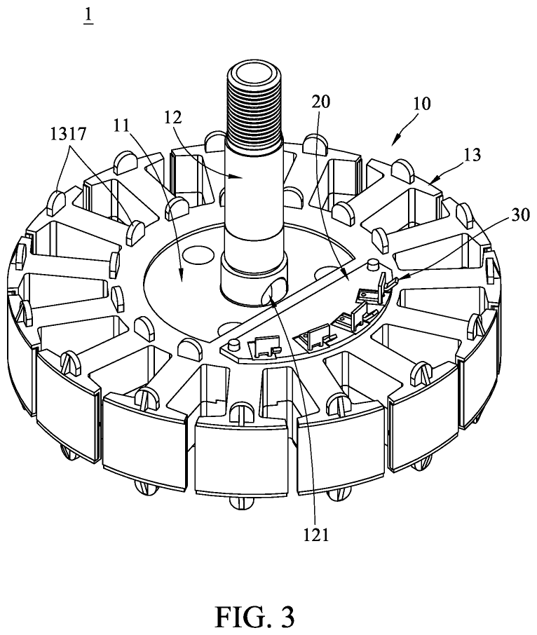

The stator 1 will be described in detail with reference to FIGS. 3-6. As shown, the stator 1 includes a stator core 10, a circuit board 20, and at least one fastener 30. The circuit board 20, the fastener 30, the wire 40, and the shaft 12 are all disposed on the stator core 10.

Specifically, the stator core 10 includes a lamination 11 which includes a yoke 111, teeth 113 radially extending outwards from the yoke 111, and shoes 115 respectively located at distal ends of the teeth 113. The yoke 111 has a shaft hole 1110 for the installation of the shaft 12. Any typical silicon steel lamination applicable to a motor can be served as the lamination 11, and the disclosure is not limited by the shape, size, material, number of sheets, and thickness of the lamination 11. And the shaft 12 can be fixedly disposed through the shaft hole 1110 of the lamination 11 in any suitable manner.

The stator core 10 further includes an insulator assembly 13 which has one or more pieces assembled together. In specific, in this embodiment, the insulator assembly 13 includes at least one insulator: an insulator 131 and an insulator 132. The insulators 131 and 132 are respectively installed at two opposite sides of the lamination 11 in any suitable manner. The insulators 131 and 132 are able to partially cover the yoke 111, the teeth 113, and the shoes 115 of the lamination 11. To fit the contour of the lamination 11, the insulators 131 and 132 each have a shape partially fitting the shape of the lamination 1. Since the insulators 131 and 132 are the same or similar in configuration, only the insulator 131 will be exemplarily described in detail in the following paragraphs.

The insulator 131 is made of any suitable insulated material. The insulator 131 includes a yoke 1311, teeth 1313 radially extending outwards from the yoke 1311, and shoes 1315 respectively located at distal ends of the teeth 1313. The yoke 1311 partially covers a surface of the yoke 111 of the lamination 11. Specifically, the yoke 1311 includes a supporting portion 13111 and an open hole 13112. The supporting portion 13111 means the solid portion of the yoke 1311 which is stacked on the yoke 111 of the lamination 11. The supporting portion 13111 is configured to support the circuit board 20; in other words, the supporting portion 13111 is used as a support for the installation of the fastener 30. The open hole 13112 means the hollow portion of the yoke 1311 which exposes the shaft hole 1110 of the yoke 111 of the lamination 11, thus the supporting portion 13111 will not have interference with the shaft 12. The teeth 1313 partially cover the teeth 113 of the lamination 11. Thus, the insulators 131 and 132 are able to prevent the wire 40 from directly contacting the teeth 113 of the lamination 11. The shoes 1315 partially cover the shoes 115 of the lamination 11. As such, it is understandable that the configurations of the yoke 1311, the teeth 1313, and the shoes 1315 of the insulator 131 are basically partially fitting that of the lamination 11 and therefore can be modified as required.

Optionally, the insulator 131 may further include a plurality of holding structures 1317 axially protruding outwards from the outer surface of the insulator 131 and respectively arranged at two opposite ends of at least one of the teeth 113. The holding structures 1317 are able to hold the shape of the stator coil formed of the wire 40 wound on each tooth 113, the holding structures 1317 are also able to support or secure the position and shape of the part of the wire 40 that crosses among the teeth 113, such that the holding structures 1317 are able to secure the required tension of the wire 40 and also able to prevent displacement of wire 40.

The circuit board 20 and the fastener 30 are described in detail below. The circuit board 20 is fixed on the supporting portion 13111 of the insulator 131 in any suitable manner. For example, in this embodiment, the insulator 131 further include a plurality of posts 1319 protruding from the supporting portion 13111, the circuit board 20 has a plurality of engagement holes 211, the engagement holes 211 are through holes suitable for the insertions of the posts 1319. Thus, as the posts 1319 penetrate through the engagement holes 211, the circuit board 20 then can be firmly fixed on the supporting portion 13111 of the insulator 131 by deforming the posts 1319 by heat. The numbers and locations of both the posts on the insulator and the mating holes can be modified as required as long as the circuit board is firmly fixed in place.

The circuit board 20 has an installation surface 21. The installation surface 21 is, for example, a surface of the circuit board 20 facing away from the insulator 131. The installation surface 21 is configured to support the fastener 30. Note that the circuit board 20 may have circuit trace distribution, electrical/non-electrical components arranged on the installation surface 21, but they are omitted from the drawings for the purpose of simple illustration. The engagement holes 211 penetrate through the installation surface 21. Optionally, there is at least one recess 212 formed on the installation surface 21. For example, the circuit board 20 has a plurality of recesses 212 spaced apart from each other by a suitable distance. Each recess 212 is configured for providing an area for the placement of the fastener 30. In this embodiment, the recesses 212 are respectively arranged adjacent to the teeth 1313 of the insulator 131. In one embodiment, the recess 212 are respectively located at positions corresponding to areas between the teeth 1313.

Regarding the installation of the fastener 30, the circuit board 20 further has a plurality of installation holes 213 for receiving part of the fastener 30. Specifically, the installation hole 213 are arranged at the recesses 212, as shown, each recess 212 has at least one installation hole 213. The installation hole 213 is a blind hole or a through hole. The fastener 30 includes a main part 31 having at least one insertion part 311. The insertion part 311 is configured to be inserted into the installation hole 213 so as to fix the fastener 30 to the circuit board 20. The insertion part 311 and the installation hole 213 may have an interference fit to achieve a firm installation of the fastener 30. In some embodiments, the insertion part 311 can be fixed in the installation hole 213 by welding process or using adhesive. Note that the insertion part 311 and installation hole 213 are an example of the fixation of fastener. In other embodiments, the fastener may omit the aforementioned insertion parts and can be directly fixed onto the circuit board via adhesive, welding, screw, or bolt.

The fastener 30 may be but is not limited to be a single piece made of any suitable electrically conductive material. In one embodiment, the fastener 30 is able to be electrically connected to the circuit board 20 by the insertion parts 311 inserted into the installation holes 213. In more detail, the fastener 30 further includes a connecting part 32 and a connecting part 33 which respectively extend outwards from two opposite sides of the main part 31. The connecting part 32 extends towards the shaft 12 from the main part 31. Optionally, the connecting part 32 extends towards the cable outlet 121 of the shaft 12. The connecting part 33 extends towards in a direction away from the shaft 12 and the insulator 131; in other words, the connecting part 33 is inclined with respect to the shaft 12 and the insulator 131. The connecting part 32 is configured for the fixation of the part of the cable 50 coming out from the cable outlet 121 of the shaft 12. The connecting part 33 is configured for the fixation of the part of the wire 40 used for connection to the cables 50. As such, the cable 50 and the parts of the wire 40, that are brought out of different phases of the stator 1, are able to be electrically coupled to each other via the fastener 30.

In detail, the shaft 12 is hollow and has the cable outlet 121, thus the cable 50 is allowed to be disposed through the shaft 12 and penetrate through the cable outlet 121 to extend towards and engage with the connecting part 32 of one of the fasteners 30. Optionally, the connecting part 32 has a through hole 321 configured for the cable 50 to penetrate therethrough, thus, the cable 50 is able to be fixed on the fastener 30 by being disposed through the through hole 321 of the connecting part 32. Optionally, the part of the cable 50 being penetrating through the through hole 321 can be bent to hook the connecting part 32. In addition, optionally, to facilitate the fixation of the cable 50 to the fastener 30, the cable outlet 121 is arranged at the side of the shaft 12 facing towards the circuit board 20; in other words, the cable outlet 121 of the shaft 12 is arranged to correspond to the fastener 30. Thus, the connecting part 32 of the fastener 30 corresponds to the cable outlet 121 of the shaft 12.

The connecting part 33 being inclined and extending away from the shaft 12 and the insulator 131 allows the parts of the wire 40, that are brought out of different phases of the stator 1, to be wound thereon. By doing so, the wire 40 can be electrically connected to the cable 50 via the fastener 30, and the part of the wire 40 being wound on the fastener 30 ensures the required shape and tension of the wire 40. Optionally, the connecting part 30 may be arranged to correspond to an area between the adjacent teeth 1313 of the insulator 131 so as to facilitate the fixation of the wire 40 onto the fastener 30.

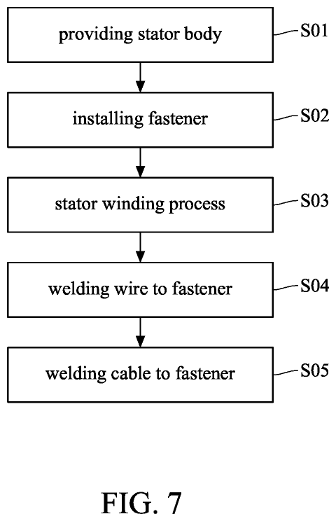

As discussed, the fasteners 3 provide places for the parts of the wires 40 brought from different phases of the stator 1 to electrically couple with the cables 50. This not only simplifies the coupling of the stator coil (i.e., the wire 40) and the power (i.e., the cable 50) but also makes it possible to introduce such coupling into an automated production line. The assembling processes of the stator 1 are given below with further reference to FIG. 7.

Firstly, in step S01, a stator core 10 is provided. Before or during step S01, the shaft 12 is disposed through the lamination 11 using any suitable automatic machine. Also, before or during step S01, the insulator 131 and the insulator 132 are assembled to the lamination 11.

Then, in step S02, one or more fasteners 30 are installed on the stator core 10. In specific, the fasteners 30 are installed on the insulator 131. More specifically, the fastener 30 is installed on the circuit board 20 by inserting the insertion parts 311 into the installation holes 213 of the circuit board 20, where the insertion parts 311 and the installation holes 213 can be firmly fixed to each other by the interference fit therebetween, welding process, or suitable adhesive. Since the process involved in installing the fastener 30 is simple, it becomes possible to employ a suitable automatic machine to implement the installation of the fastener 30. The circuit board 20 can be arranged to the predetermined area of the supporting portion 13111 of the insulator 131 as the posts 1319 of the insulator 131 are inserted into the engagement holes 211, and then the posts 1319 are deformed so secure the circuit board 20 to the insulator 131. As such, the circuit board 20 and the fasteners 30 thereon can be installed to the insulator 131 as an assembly. Since the process involved in installing the circuit board 20 is simple, it is possible to employ a suitable automatic machine to implement the installation of the circuit board 20 to the supporting portion 13111 of the insulator 131. In short, the fastener 30 is fixed to the insulator 131 via the circuit board 20, and the installations of both the fastener 30 and the circuit board 20 can be imported into an automated production line and therefore implemented automatically.

Step S03 is a stator winding process. During step S03, the wire 40 is wound around the teeth of the insulators 131 and 132 to form stator coils. It is known that winding the wire 40 around the insulators 131 and 132 is implementable using any suitable stator winding machine. Parts of the wire 40 will be wound on the fasteners 30 as well during step S03. In detail, since the connecting parts 33 of the fasteners 30 allow the wire 40 to be wound thereon, the selected part of the wire 40, which is brought out of the stator core 10 for connection or being served as a lead wire, is also allowed to be automatically wound on the fasteners 30 during the stator winding process by the stator winding machine. Optionally, after the wire 40 had been wound on the connecting part 33, the connecting part 33 then can be bent to further secure the position of the wire 40 between the connecting part 30 and the main part 31.

Then, step S04 is to weld the wire 40 to the fastener 30. In detail, since the fastener 30 can be served as a predetermined place for the wire 40 to wind on, winding the wire 40 on the connecting part 33 of the fastener 30 as well as welding it on the connecting part 33 are implementable by a typical automatic winding machine and spot welding equipment. Optionally, any later process for further improving the part of the wire 40 being welded on the fastener 30 can be involved.

Step S05 is to weld the cable 50 to the fastener 30. In detail, part of the cable 50 which comes out of the cable outlet 121 of the shaft 12 can penetrate through the through hole 321 of the connecting part 32 of the fastener 30. Optionally, the part of the cable 50 disposed through the through hole 321 can be bent to further firmly hook the connecting part 32. By doing so, the part of the cable 50 being fixed on the fastener 30 can be served as a predetermined place for a suitable automatic spot welding equipment to weld the cable 50 to the connecting part 32. By the above steps, the wire 40 and the cable 50 are able to be electrically coupled to each other via the fastener 30. It is noted that the order of the aforementioned steps may be changed as required. For example, in other embodiments, the step S05 may be performed before the step S03 and step S04.

By following the aforementioned steps, the stator 1 is completed and ready to do required basic testing. As the method of the disclosure discussed above, the configuration of the stator 1 allows automatic equipment to get involved to implement the fixation and electrical coupling of the wire routing and cables terminals, thus manually implemented processes (e.g., wire and cable arrangement and bundling and adding protection sleeves and cable ties), are no longer needed; that is, the method of the disclosure prevents the problems due to troublesome and time-consuming works that are heavily relying on manual human labor. Accordingly, the method of assembling the stator 1 significantly saves labor costs and therefore is beneficial to improve efficiency, quality, production yield, and productivity.

Herein, please refer table 1 below, the table 1 shows a conventional manufacturing steps for stator. As shown, except for the process of winding wires on stator core which can be automatically implemented in coil winding station, the later processes, such as wires and cable arrangement, trimming, and bundling and adding protection sleeves, heat shrink tubing, and cable ties, can only be implemented manually, where the protection sleeves, heat shrink tubing, and cable ties are provided for securing the connection between the wires and the cables. As a result, the conventional stator manufacturing process highly relies on troublesome and time-consuming manual works and therefore is costly and inefficient. As can be seen below, the conventional stator manufacturing process needs 505 seconds at minimum. And it is known that high relying on human labor inevitably would be difficult to achieve a balance between quality and production yield.

TABLE 1

| No. | processes | time(second) |
|---|---|---|
| 1 | placing shaft into silicon steel | 40 |
| | sheet and installing insulator | |
| 2 | winding the stator core | 135 |
| 3 | trimming and arranging wires | 25 |
| 4 | bundling wires for lead wire | 40 |
| 5 | arranging cables | 5 |
| 6 | sleeving the cables with | 20 |
| | protection sleeves | |
| 7 | bundling cables and lead wires | 80 |
| 8 | welding lead wires and cables | 50 |
| 9 | wires and cable arrangement | 30 |
| 10 | sleeving heat shrink tubing | 10 |
| 11 | adding cable ties on cables | 10 |
| 12 | electrical testing | 60 |

| | |
|---|---|
| total time | 505 |

Then, please see table 2 below, the table 2 shows the assembling method of the aforementioned embodiments of the disclosure. As shown, with the fastener, the fixations of the wires and the cables can be automatically completed during the winding process and which enables the import of automatic welding process for the lead wires. The fastener also allows the ends of the cables to be arranged and welded at specific places so that they are able to be automatically coupled to the wires. As such, the arrangement and connection of the cables and the wires can be implemented using automatic machines and thus avoiding troublesome and time-consuming manual works, such as arranging and bundling wires and cable and adding protection sleeves, heat shrink tubing, and cable ties. As can be seen below, due to the fastener as discussed in the embodiments of the disclosure, the stator manufacturing steps are reduced and simplified (12 steps to 7 steps) and can be implemented by automatic equipment, thus the total time is shortened to about 313 seconds. As a result, most of the conventional manual processes are replaced by automatic processes contributed by the fastener of the disclosure, thereby significantly saving labor costs and achieving a great improvement in efficiency, quality, production yield, and productivity.

TABLE 2

| No. | processes | time(second) |
|---|---|---|
| 1 | steps S01-S02: installing shaft and | 60 |
| | installing insulators and fasteners | |
| 2 | step S03: winding the stator core | 120 |
| 3 | step S04: automatically welding | 40 |
| | wires to fastener | |
| 4 | trimming and arranging wires | 8 |
| 5 | arranging cables along shaft | 5 |
| 6 | step S05: automatically welding | 40 |
| | cables to fastener | |
| 7 | electrical testing | 40 |

| | |
|---|---|
| total time | 313 |

In addition, as discussed above, while the wires 40 are automatically wound on the fasteners 30, the holding structures 1317 of the insulator 131 are able to support or secure the position and shape of the stator coil formed of the wire 40 and the parts of the wire 40 that crosses between different teeth 113, such that the holding structures 1317 are able to secure the required tension of the wire 40 and also to prevent displacement of wire 40, thereby assisting in improving performance of the motor 8 in various aspects, such as high inductance and low vibration.

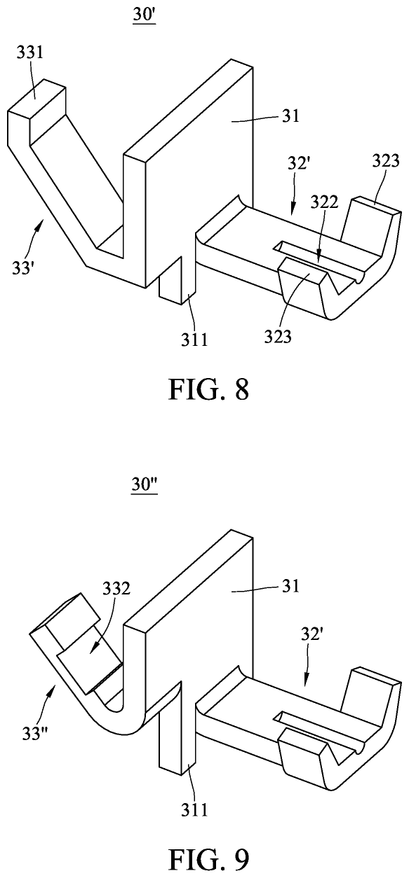

It is noted that the aforementioned fasteners are exemplary but not limiting. Please refer to FIG. 8, another embodiment of the disclosure provides a fastener 30′, the difference between the fastener 30′ and the previous fastener 30 is that a connecting part 32′ of the fastener 30′ has a notch 322 and two press tabs 323 thereon, the notch 322 is formed on the upper surface of the connecting part 32′, the press tabs 323 are located at two opposite sides of the distal end of the connecting part 32′. The cable 50 can be temporarily disposed in the notch 322, then the press tabs 323 can be folded inwards to secure the position of the cable 50 on the connecting part 32′. In addition, the fastener 30′ has an extension part 331 located at the distal end of a connecting part 33′ thereof, and the angle of the extension part 331 makes it possible to prevent the wire 40 from loosening from the connecting part 33′.

Please refer to FIG. 9, another embodiment of the disclosure provides a fastener 30″, the difference between the fastener 30″ and the previous fasteners is that the fastener 30″ has a positioning recess 332 arranged on a connecting part 33″ for facilitating the winding of the wire 40 onto the fastener 30″. In specific, the wire 40 is prevented from slipping as it is restricted by the positioning recess 332.

It is noted that the circuit board between the fasteners and the insulator is optional but not limiting. For example, in a stator of other embodiments of the disclosure, the fastener may be directly disposed on the insulator in any suitable manner as long as the fastener enables the fixations of the wire and cable as well as the electrical connection between the wire and the cable. In addition, the number of the fastener on one stator may be modified as required; for example, in a stator core of other embodiments of the disclosure, there may be only one fastener arranged on the stator core.

According to the stator, the motor, and the stator assembling method as discussed in the above embodiments of the disclosure, the fastener provided on the insulator of the stator can be used for the fixation of both the wire and the cable, thus the parts of the wires, that are from different phases or brought out of the stator core for connection, and the cables are allowed to be automatically fixed together during an automatic stator winding process, avoiding manually arranging and bundling wires and cables. Also, since the wires and the cable can be automatically fixed to the fastener, the wires and the cables can be automatically welded to build a reliable connection without the need of protection sleeve or cable tie. As such, the fastener as discussed above makes the fixation and electrical coupling of the cable and wire possible to be automatically performed, thus the conventional manual processes, such as wire and cable arrangement, bundling, welding, adding protection sleeve and cable tie, all can be replaced by automatic processes contributed by the fastener, thereby significantly saving labor costs while achieving a great improvement in efficiency, quality, production yield, and productivity.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A stator comprising:
a stator core comprising:
a lamination;
a shaft disposed through the lamination; and
at least one insulator disposed on the lamination and configured to be wound with a wire; and
at least one fastener disposed on the at least one insulator, wherein the at least one fastener is configured for the wire to be wound thereon and for fixing at least one cable coming out from the shaft so as to electrically couple the wire and the at least one cable.

2. The stator according to claim 1, wherein the shaft is hollow and has a cable outlet for the at least one cable, the at least one fastener corresponds to the cable outlet.

3. The stator according to claim 1, wherein the at least one fastener comprises two connecting parts respectively located at two opposite sides of the at least one fastener, one of the two connecting parts extends towards the shaft and is configured for fixing the at least one cable, another one of the two connecting parts extends away from the shaft and is configured for fixing the wire.

4. The stator according to claim 3, wherein one of the two connecting parts is inclined with respect to the shaft and the at least one insulator.

5. The stator according to claim 3, wherein one of the two connecting parts has a through hole configured for an insertion of the at least one cable.

6. The stator according to claim 3, wherein one of the two connecting parts corresponds to an area between a plurality of teeth of the at least one insulator.

7. The stator according to claim 3, wherein one of the two connecting parts has a notch and two press tabs, the notch is configured for a placement of the at least one cable, the two press tabs are configured to be folded to hold the at least one cable.

8. The stator according to claim 3, wherein one of the two connecting parts has a positioning recess configured to be wound by the wire.

9. The stator according to claim 3, wherein there is an extension part located at an end of one of the two connecting parts.

10. The stator according to claim 1, wherein the at least one insulator comprises a yoke and a plurality of teeth, the plurality of teeth radially extends outwards from the yoke and configured for the wire to wind thereon, the yoke comprises a supporting portion and an open hole, the at least one fastener is disposed on the supporting portion, the shaft is disposed through the open hole.

11. The stator according to claim 10, wherein the at least one insulator further comprises a plurality of holding structures axially protruding outwards from an outer surface from the at least one insulator, the plurality of holding structures are arranged at two opposite ends of at least one of the plurality of teeth and are configured for restricting the wire wound on the plurality of teeth.

12. The stator according to claim 1, further comprising a circuit board, wherein the at least one fastener is disposed on the at least one insulator via the circuit board.

13. A motor, comprising:
a rotor; and
a stator comprising:
a stator core comprising:
a lamination accommodated in the rotor;
a shaft disposed through the lamination and the rotor; and
at least one insulator disposed on the lamination and configured to be wound with a wire; and
at least one fastener disposed on the at least one insulator, wherein the at least one fastener is configured for the wire to be wound thereon and for fixing at least one cable coming out from the shaft so as to electrically couple the wire and the at least one cable.

14. The motor according to claim 13, wherein the shaft is hollow and has a cable outlet for the at least one cable, the at least one fastener corresponds to the cable outlet.

15. The motor according to claim 13, wherein the at least one fastener comprises two connecting parts respectively located at two opposite sides of the at least one fastener, one of the two connecting parts extends towards the shaft and is configured for fixing the at least one cable, another one of the two connecting parts extends away from the shaft and is configured for fixing the wire.

16. The motor according to claim 15, wherein one of the two connecting parts is inclined with respect to the shaft and the at least one insulator.

17. The motor according to claim 15, wherein one of the two connecting parts has a through hole configured for an insertion of the at least one cable.

18. The motor according to claim 15, wherein one of the two connecting parts corresponds to an area between a plurality of teeth of the at least one insulator.

19. The motor according to claim 15, wherein one of the two connecting parts has a notch and two press tabs, the notch is configured for a placement of the at least one cable, the two press tabs are configured to be folded to hold the at least one cable.

20. The motor according to claim 15, wherein one of the two connecting parts has a positioning recess configured to be wound by the wire.

21. The motor according to claim 15, wherein one of the two connecting parts has an extension at an end thereof.

22. The motor according to claim 13, wherein the at least one insulator comprises a yoke and a plurality of teeth, the plurality of teeth radially extends outwards from the yoke and configured for the wire to wind thereon, the yoke comprises a supporting portion and an open hole, the at least one fastener is disposed on the supporting portion, the shaft is disposed through the open hole.

23. The motor according to claim 22, wherein the at least one insulator further comprises a plurality of holding structures axially protruding outwards from an outer surface from the at least one insulator, the plurality of holding structures are arranged at two opposite ends of at least one of the plurality of teeth and are configured for restricting the wire wound on the plurality of teeth.

24. The motor according to claim 13, wherein the stator further comprises a circuit board, the at least one fastener is disposed on the at least one insulator via the circuit board.

25. A stator assembling method, comprising:
providing a stator core;
assembling at least one fastener on at least one insulator of a lamination of the stator core;
winding a wire onto the at least one insulator and fixing the wire to the at least one fastener; and
fixing at least one cable coming out from a shaft of the stator core to the at least one fastener.

26. The stator assembling method according to claim 25, after fixing the wire to the at least one fastener, further comprising:
winding the wire onto the at least one fastener; and
welding the wire to the at least one fastener.

27. The stator assembling method according to claim 25, after fixing the at least one cable to the at least one fastener, further comprising:
welding the at least one cable to the at least one fastener.

28. The stator assembling method according to claim 25, wherein in the step of assembling the at least one fastener to the at least one insulator comprises:
fixing the at least one fastener to a circuit board; and
fixing the circuit board to the at least one insulator.
